(19) United States
(12) Patent Application Publication
(10) Pub. No.: US 2025/0343288 A1
(43) Pub. Date: Nov. 6, 2025

(54) ENERGY STORAGE APPARATUS, MANAGEMENT APPARATUS, METHOD FOR ESTIMATING TEMPERATURE OF ENERGY STORAGE DEVICE, AND COMPUTER PROGRAM

(71) Applicant: GS Yuasa International Ltd., Kyoto-shi (JP)

(72) Inventors: Mitsushi MUKAIDA, Kyoto-shi (JP); Kodai TOKIYASU, Kyoto-shi (JP); Seiji TAKAI, Kyoto-shi (JP); Atsushi FUKUSHIMA, Kyoto-shi (JP); Sadaharu MORITO, Kyoto-shi (JP); Akihito UMEDA, Kyoto-shi (JP)

(21) Appl. No.: 19/266,430

(22) Filed: Jul. 11, 2025

Related U.S. Application Data
(63) Continuation of application No. PCT/JP2023/043762, filed on Dec. 7, 2023.

(30) Foreign Application Priority Data
Jan. 19, 2023 (JP) 2023-006811

(51) Int. Cl. H01M 10/48; H01M 10/42; H01M 50/209; H01M 50/284; H01M 50/507; H01M 50/519

(52) U.S. Cl. CPC H01M 10/486; H01M 10/425; H01M 50/209; H01M 50/284; H01M 2010/4271; H01M 50/507; H01M 50/519

(57) ABSTRACT

An energy storage apparatus includes an energy storage device, a first temperature sensor to measure a temperature of an area on a circuit board or a first area at or adjacent to an interior of the energy storage device, a second temperature sensor to measure an ambient temperature of the circuit board or a temperature of a second area that is farther from the interior of the energy storage device than the first area, and an arithmetic device including a processor and a memory, the memory including a program that is executable by the processor to cause the processor to estimate a temperature of the energy storage device based on a temperature gradient between the temperature measured by the first temperature sensor and the temperature measured by the second temperature sensor.

### CROSS REFERENCE TO RELATED APPLICATIONS

This application claims the benefit of priority to Japanese Patent Application No. 2023-006811 filed on Jan. 19, 2023 and is a Continuation Application of PCT Application No. PCT/JP2023/043762 filed on Dec. 7, 2023. The entire contents of each application are hereby incorporated herein by reference.

### BACKGROUND OF THE INVENTION

### 1. Field of the Invention

The present invention relates to energy storage apparatuses, management apparatuses, methods for estimating temperatures of energy storage devices, and non-transitory computer-readable media including computer programs.

### 2. Description of the Related Art

In order to safely use an energy storage apparatus including an energy storage device and maximize performance, it is important to accurately detect the internal temperature of the energy storage device.

Conventionally, the temperature of the case top surface of the energy storage device is measured and used as the internal temperature of the energy storage device (see, for example, JP-A-2017-59503).

### SUMMARY OF THE INVENTION

However, the temperature of the case top surface of the energy storage device is different from the internal temperature of the energy storage device. To make allowance for the difference, it is necessary to increase the safety margin of a threshold used for monitoring (for example, a threshold for detecting high-temperature anomalies), which makes it difficult to maximize the performance of the energy storage device.

Example embodiments of the present invention provide energy storage apparatuses, management apparatuses, methods for estimating temperatures of energy storage devices, and non-transitory computer-readable media including computer programs that enable proper estimation of the temperatures of the energy storage devices.

An energy storage apparatus according to an example embodiment of the present invention includes an energy storage device, a circuit board, a first temperature sensor to measure a temperature of an area on the circuit board or a first area at or adjacent to an interior of the energy storage device, a second temperature sensor to measure an ambient temperature of the circuit board or a temperature of a second area that is farther from the interior of the energy storage device than the first area, and an arithmetic device including a processor and a memory, the memory including a program that is executable by the processor to cause the processor to estimate a temperature of the energy storage device based on a temperature gradient between the temperature measured by the first temperature sensor and the temperature measured by the second temperature sensor.

According to example embodiments of the present invention, temperatures of energy storage devices can be properly estimated.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a configuration example of an energy storage apparatus according to an example embodiment of the present invention.

FIG. 2 is an exploded perspective view of the energy storage apparatus.

FIG. 3 is a plan view illustrating the arrangement of busbars.

FIG. 4 is an exploded perspective view illustrating the arrangement of the busbars.

FIG. 5 is a plan view for explaining the configuration of a circuit board.

FIG. 6 is a block diagram illustrating the internal configuration of a management apparatus.

FIG. 7 is a graph showing temporal changes in substrate temperature and cell internal temperature when environmental temperature is abruptly changed.

FIG. 8 is a circuit diagram representing a thermal circuit model of the energy storage apparatus.

FIG. 9 is a graph showing temporal changes in ratio.

FIG. 10 is a flowchart illustrating a processing procedure performed by a management apparatus according to a first example embodiment of the present invention.

FIG. 11 is a graph showing estimation results in the first example embodiment of the present invention.

FIG. 12 is an explanatory diagram for explaining the arrangement of first temperature sensors in a second example embodiment of the present invention.

FIG. 13 is a graph showing estimation results in the second example embodiment of the present invention.

FIG. 14 is an explanatory diagram for explaining the timing of switching between a temperature gradient method and a Joule heat method.

FIG. 15 is a flowchart illustrating a processing procedure performed by a management apparatus according to a third example embodiment of the present invention.

### DETAILED DESCRIPTION OF THE EXAMPLE EMBODIMENTS

(1) An energy storage apparatus according to an example embodiment of the present disclosure includes an energy storage device, a circuit board, a first temperature sensor to measure a temperature of an area on the circuit board or a first area at or adjacent to an interior of the energy storage device, a second temperature sensor to measure an ambient temperature of the circuit board or a temperature of a second area that is farther from the interior of the energy storage device than the first area, and an arithmetic device including a processor and a memory, the memory including a program that is executable by the processor to cause the processor to estimate a temperature of the energy storage device based on a temperature gradient between the temperature measured by the first temperature sensor and the temperature measured by the second temperature sensor.

The energy storage apparatus may further include a heat transfer structure to transfer heat of the energy storage device to the circuit board. The first temperature sensor may measure the temperature of a connection area on the circuit board to which the heat transfer structure is connected.

The heat transfer structure connecting the energy storage device and the circuit board has thermal resistance (resistance to heat transfer) corresponding to its shape and material. By using the heat transfer structure, the temperature of the energy storage device can be estimated from the temperature of an area (for example, the connection area) away from the energy storage device. This can increase the degree of freedom in designing the circuit board and the energy storage apparatus, and allows the adoption of a design of the energy storage apparatus suitable for mass production.

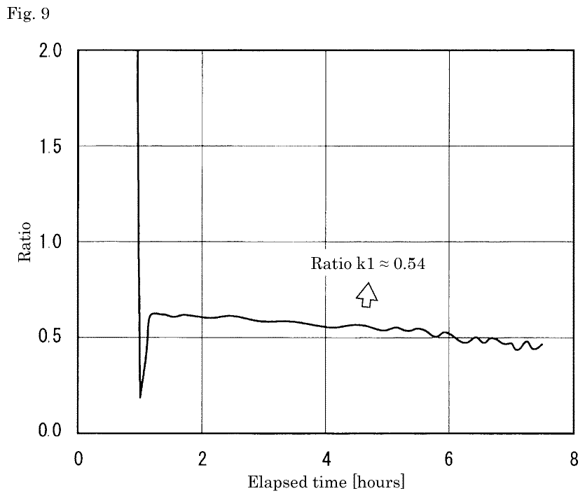

Alternatively, the temperature of the energy storage device may be estimated from the temperature of the first area (nearby area) close to the interior of the energy storage device. Here, the first area whose temperature is measured by the first temperature sensor refers to an area closer to the interior of the energy storage device than the area measured by the second temperature sensor. The temperature of the first area well reflects the temperature of the energy storage device. Thus, by using the temperature of the first area, the temperature of the energy storage device can be properly estimated. The inventors of the present application have found that the ratio of the difference between the ambient temperature and the temperature of the area (for example, the connection area) on the circuit board or the first area to the difference between the temperature of the area (for example, the connection area) on the circuit board or the first area and the temperature (internal temperature) of the energy storage device is nearly constant regardless of the lapse of time (see FIG. 9). In the energy storage apparatus of (1), the temperature of the energy storage device can be properly estimated by applying a temperature gradient method that takes into account the temperature gradient between the temperature measured by the first temperature sensor and the temperature measured by the second temperature sensor.

(2) In the energy storage apparatus according to (1), the energy storage apparatus may include a plurality of the energy storage devices adjacent to each other, and the arithmetic device may be configured or programmed to estimate the temperature of each energy storage device based on the difference between the temperature measured by the first temperature sensor and the temperature measured by the second temperature sensor, and the difference between the temperature of the area on the circuit board or the first area and the temperature of the energy storage device acquired in advance.

In many cases, the energy storage apparatus includes the plurality of energy storage devices adjacent to each other. The energy storage devices differ in distance from the connection area on the circuit board or the first area, and also differ in heat retention (ease of heat dissipation). The energy storage apparatus of (2) acquires in advance the difference between the internal temperature and the temperature of the connection area or the first area, and thus can properly estimate the temperature of each energy storage device.

(3) The energy storage apparatus according to (1) or (2) may further include a heat-generating component provided on the circuit board, and a third sensor to measure a state of the heat-generating component. According to the state measured by the third sensor, the arithmetic device may be configured or programmed to estimate the temperature of the energy storage device, based on the current flowing through the energy storage device instead of the temperature gradient.

The third sensor may be a temperature sensor to measure the temperature of the heat-generating component or a current sensor to measure the current flowing through the heat-generating component.

The influence of heat from the heat-generating component provided on the circuit board may reduce the accuracy of temperature estimation of the energy storage device with the method using heat transfer through the heat transfer structure. For example, when the heat generation of a balancer to balance the charge states (or voltages) of the plurality of energy storage devices increases, the actual thermal behavior cannot be simulated by a thermal resistance model on which the temperature gradient method is based (see FIG. 8). The energy storage apparatus of (3) switches to a method based on the current flowing through the energy storage device to perform temperature estimation, according to the measured value of the third sensor, and thus can increase the accuracy of the temperature estimation.

(4) In the energy storage apparatus according to (3), the heat-generating component may be a switch configured to turn on or off energization of the energy storage device.

The switch may be a semiconductor switch, a relay, or another on-board switch.

The influence of heat from the switch provided on the circuit board as a breaker to protect the energy storage device may reduce the accuracy of temperature estimation of the energy storage device with the method using heat transfer through the heat transfer structure. For example, when the energy storage device is charged or discharged at high rates, the heat generation of the switch increases, making it impossible to simulate the actual thermal behavior with the thermal resistance model on which the temperature gradient method is based. The energy storage apparatus of (4) switches to the method based on the current flowing through the energy storage device to perform temperature estimation, according to the measured value of the third sensor, and thus can increase the accuracy of the temperature estimation.

(5) A management apparatus according to an example embodiment of the present disclosure includes a processor, a memory including a program executable by the processor to function as an acquisition unit configured or programmed to acquire temperature data from a first temperature sensor to measure the temperature of an area on a circuit board or a first area at or adjacent to the interior of an energy storage device, and a second temperature sensor to measure the ambient temperature of the circuit board or the temperature of a second area that is farther from the interior of the energy storage device than the first area, and an estimation unit configured or programmed to estimate the temperature of the energy storage device based on the temperature gradient between the temperature measured by the first temperature sensor and the temperature measured by the second temperature sensor.

The management apparatus of (5) can properly estimate the temperature of the energy storage device by applying a temperature gradient method.

(6) A method for estimating a temperature of an energy storage device according to an example embodiment of the present invention includes processing performed by a computer including acquiring temperature data from a first temperature sensor to measure the temperature of an area on a circuit board or a first area at or adjacent to the interior of the energy storage device, acquiring temperature data from a second temperature sensor to measure the ambient temperature of the circuit board or the temperature of a second area that is farther from the interior of the energy storage device than the first area, and estimating the temperature of the energy storage device based on the temperature gradient between the temperature measured by the first temperature sensor and the temperature measured by the second temperature sensor.

The method for estimating the temperature of the energy storage device of (6) enables proper estimation of the temperature of the energy storage device by applying a temperature gradient method.

(7) A non-transitory computer-readable medium according to an example embodiment of the present invention includes a computer program executable to cause a computer to perform processing including acquiring temperature data from a first temperature sensor to measure the temperature of an area on a circuit board or a first area at or adjacent to the interior of an energy storage device, acquiring temperature data from a second temperature sensor to measure the ambient temperature of the circuit board or the temperature of a second area that is farther from the interior of the energy storage device than the first area, and estimating the temperature of the energy storage device based on the temperature gradient between the temperature measured by the first temperature sensor and the temperature measured by the second temperature sensor.

The non-transitory computer-readable medium including a computer program of (7) enables proper estimation of the temperature of the energy storage device by applying a temperature gradient method.

Hereinafter, the present invention will be described in detail with reference to the drawings illustrating example embodiments thereof.

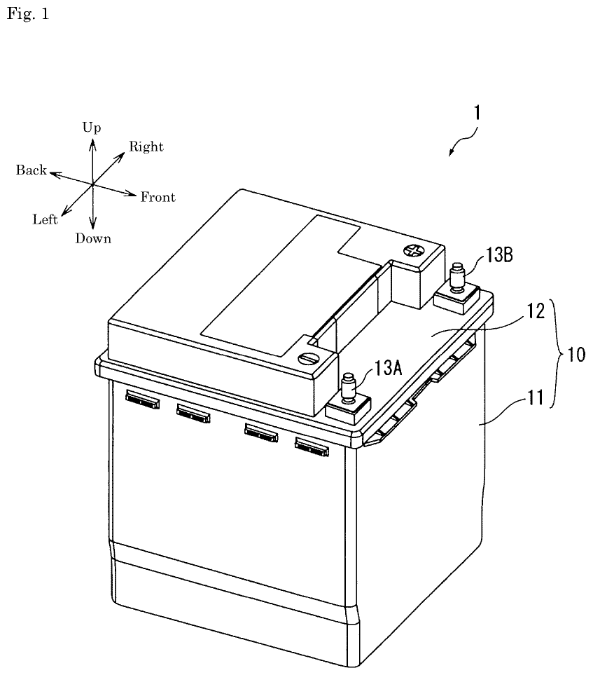

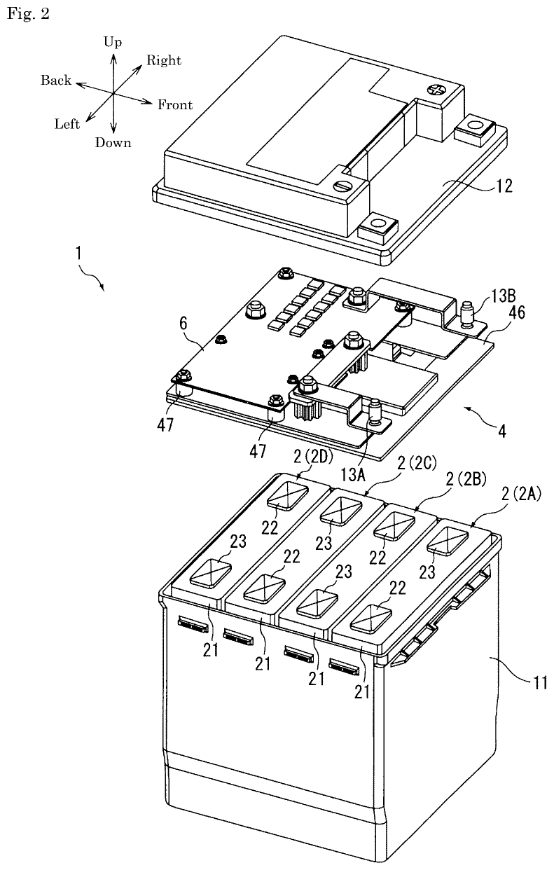

FIG. 1 is a perspective view illustrating a configuration example of an energy storage apparatus 1 according to an example embodiment. FIG. 2 is an exploded perspective view of the energy storage apparatus 1. The following describes the configuration example of the energy storage apparatus 1 with reference to “front-back”, “left-right”, and “up-down” directions shown in the drawings.

The energy storage apparatus 1 is, for example, a battery suitably mounted on a vehicle such as an engine vehicle, an electric vehicle (EV), a hybrid electric vehicle (HEV), or a plug-in hybrid electric vehicle (PHEV), or another mobile object.

The energy storage apparatus 1 includes energy storage devices 2, a busbar unit 4, and a circuit board 6. The energy storage devices 2, the busbar unit 4, and the circuit board 6 are housed in a housing case 10. The housing case 10 is made of synthetic resin. The housing case 10 includes a case body 11 open at the top, and a cover 12 that covers the opening of the case body 11. The dimensions of the case body 11 and the cover 12 are designed according to the dimensions and the number of the energy storage devices 2 housed inside. The case body 11 and the cover 12 are liquid-tightly fixed to each other with fasteners such as screws or an adhesive or by welding, or the like, with the energy storage devices 2, the busbar unit 4, and the circuit board 6 housed therein.

The energy storage devices 2 are, for example, battery cells using lithium ion secondary batteries. Each energy storage device 2 includes a case 21 having a hollow rectangular parallelepiped shape. On the upper surface of the case 21, a positive terminal 22 and a negative terminal 23 of the energy storage device 2 are provided. An electrode assembly, an electrolyte solution, and the like are held in the case 21.

The electrode assembly, which is not illustrated in detail, is constructed with a sheet-shaped positive electrode and a sheet-shaped negative electrode stacked with two sheet-shaped separators interposed therebetween, and rolled (vertically or horizontally). The separators are formed of porous resin films. As the porous resin films, porous resin films made of resin such as polyethylene (PE) or polypropylene (PP) can be used.

The positive electrode is an electrode plate with a positive active material layer formed on the surface of an elongated strip-shaped positive electrode substrate made of, for example, aluminum, an aluminum alloy, or the like. The positive active material layer contains a positive active material. As the positive active material used in the positive active material layer, a material capable of absorbing and releasing lithium ions can be used. Examples of the positive active material include LiFePO₄. The positive active material layer may further contain a conduction aid, a binder, and the like.

The negative electrode is an electrode plate with a negative active material layer formed on the surface of an elongated strip-shaped negative electrode substrate made of, for example, copper, a copper alloy, or the like. The negative active material layer contains a negative active material. As the negative active material, a material capable of absorbing and releasing lithium ions can be used. Examples of the negative active material include graphite, hard carbon, soft carbon, and the like. The negative active material layer may further contain a binder, a thickener, and the like.

As the electrolyte, the same one as that of conventional lithium ion secondary batteries can be used. For example, an electrolyte containing a supporting salt in an organic solvent can be used as the electrolyte. As the organic solvent, for example, aprotic solvents such as carbonates, esters, and ethers are used. As the supporting salt, for example, lithium salts such as LiPF₆, LiBF₄, and LiClO₄ are suitably used. The electrolyte may contain, for example, various additives such as a gas-generating agent, a film-forming agent, a dispersant, and a thickener.

In the present example embodiment, the energy storage devices 2 are battery cells using lithium ion secondary batteries. Alternatively, the energy storage devices 2 may be battery cells using all-solid-state batteries, lead-acid batteries, redox flow batteries, zinc-air batteries, alkaline-manganese batteries, lithium-sulfur batteries, sodium-sulfur batteries, silver oxide-zinc batteries, nickel-hydrogen batteries, molten salt thermal batteries, or the like, or may be capacitors.

In the present example embodiment, the energy storage devices 2 are prismatic battery cells including a rolled electrode assembly. Alternatively, the energy storage devices 2 may be cylindrical battery cells or laminated (pouched) battery cells, or may be battery cells including a stacked electrode assembly.

In the present example embodiment, the number of the energy storage devices 2 housed in the case body 11 is four. Alternatively, the number of the energy storage devices 2 housed in the case body 11 may be one or more and less than four, or may be more than four.

In the following description, the energy storage devices 2 are also referred to as a first energy storage device 2A, a second energy storage device 2B, a third energy storage device 2C, and a fourth energy storage device 2D from the front side of the case body 11 in this order. That is, the second energy storage device 2B is disposed adjacent to the rear surface of the first energy storage device 2A, the third energy storage device 2C is disposed adjacent to the rear surface of the second energy storage device 2B, and the fourth energy storage device 2D is disposed adjacent to the rear surface of the third energy storage device 2C. In the example of FIG. 2, the first energy storage device 2A and the third energy storage device 2C are housed in the case body 11 in an orientation in which the positive terminal 22 is on the left and the negative terminal 23 is on the right, and the second energy storage device 2B and the fourth energy storage device 2D are housed in the case body 11 in an orientation in which the positive terminal 22 is on the right and the negative terminal 23 is on the left.

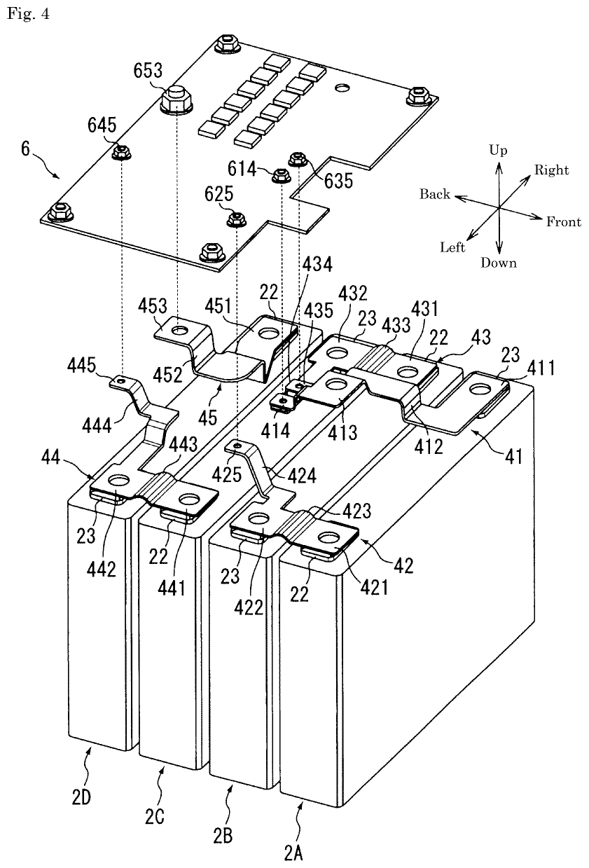

The busbar unit 4 is disposed on the terminal surfaces of the energy storage devices 2. The busbar unit 4 includes a plurality of busbars 41 to 45 (see FIG. 4) and a busbar frame 46 made of resin that holds the busbars 41 to 45. The busbar frame 46 covers the upper side of the plurality of energy storage devices 2 to block radiant heat emitted from the plurality of energy storage devices 2. The circuit board 6 is disposed on the upper surface of the busbar frame 46. The circuit board 6 is fixed to the busbar frame 46 via spacers 47 in a state of being separated from the upper surface of the busbar frame 46. Since the busbar frame 46 and a heat insulating layer such as air are present between the circuit board 6 and the energy storage devices 2, the circuit board 6 is disposed to be thermally separated from the energy storage devices 2. In the present example embodiment, metal members directly connecting the circuit board 6 and the energy storage devices 2 are only the busbars 41 to 45. Except for portions insert-molded into the busbar frame 46, the busbars 41 to 45 are exposed to air forming the heat insulating layer between the circuit board 6 and the energy storage devices 2 without being covered with resin or the like. Thus, heat hardly escapes from the busbars 41 to 45 through resin members.

The busbars 41 to 45 included in the busbar unit 4 form charge-discharge paths for the energy storage devices 2. The busbars 41 to 45 are made of metal and are formed of a material having excellent conductivity and high thermal conductivity, such as aluminum, an aluminum alloy, copper, a copper alloy, or stainless steel.

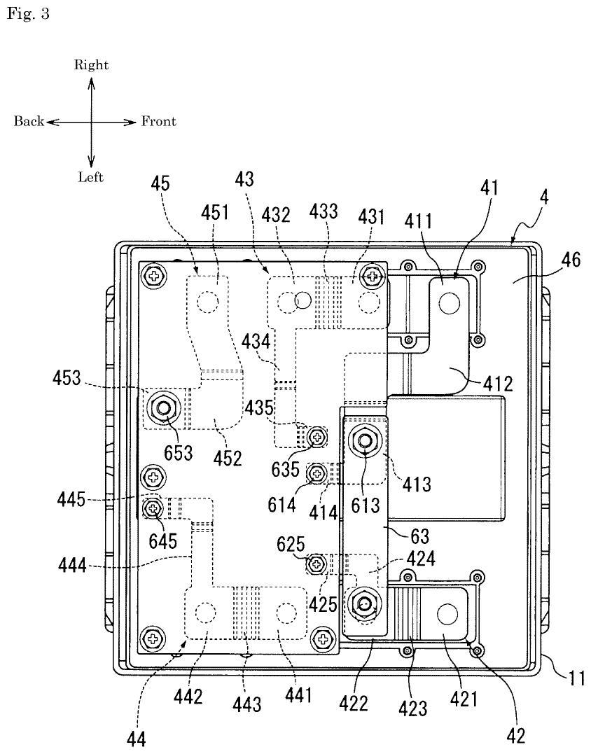

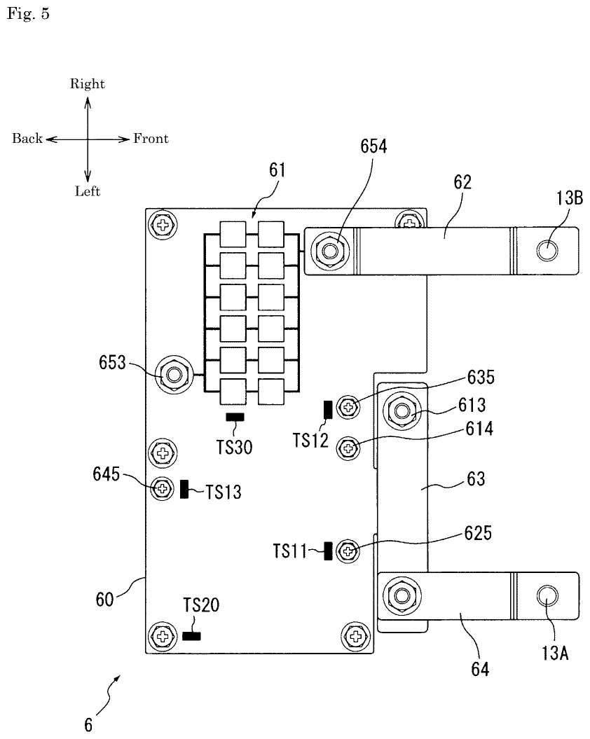

The following describes the arrangement of the busbars 41 to 45. FIG. 3 is a plan view illustrating the arrangement of the busbars 41 to 45. FIG. 4 is an exploded perspective view illustrating the arrangement of the busbars 41 to 45. In FIGS. 3 and 4, some parts are omitted for the sake of explanation. The busbar 41 is a member for connecting the negative terminal 23 of the first energy storage device 2A to one external terminal 13A. The busbar 41 includes a base portion 411, a bent portion 412, a first connecting portion 413, and a second connecting portion 414. The base portion 411 is joined to the negative terminal 23 of the first energy storage device 2A. For joining, an existing technique such as welding is used. The bent portion 412 is a member that rises from within the same plane as that of the base portion 411 to the height position of a conductor 63, and connects the base portion 411 and the first connecting portion 413. The first connecting portion 413 is connected to one end of the conductor 63 with a fastener 613 such as a screw. The conductor 63 is a plate-shaped member having excellent conductivity, such as aluminum, an aluminum alloy, copper, a copper alloy, or stainless steel. To the other end of the conductor 63, the external terminal 13A is connected via a busbar 64 (see FIG. 5). The conductor 63 is disposed as a shunt resistor for detecting the current flowing through the external terminal 13A. The second connecting portion 414 is a member connected to the rear end of the first connecting portion 413, and is connected to the lower surface of the circuit board 6 with a fastener 614 such as a screw. The second connecting portion 414 connected to the circuit board 6 is narrower in width in plan view, and has a smaller cross-sectional area than the other portions (portions forming a charge-discharge path (power line)) of the busbar 41.

The busbar 42 electrically connects the positive terminal 22 of the first energy storage device 2A and the negative terminal 23 of the second energy storage device 2B. The busbar 42 includes a first base portion 421, a second base portion 422, a curved portion 423, a bent portion 424, and a connecting portion 425. The first base portion 421 is joined to the positive terminal 22 of the first energy storage device 2A. The second base portion 422 is joined to the negative terminal 23 of the second energy storage device 2B. For joining, an existing technique such as welding is used. The curved portion 423 is a semi-annular member curved upward. The curved portion 423 is provided to accommodate a difference in height between the energy storage devices 2 due to manufacturing variation, to maintain electrical connection between the terminals. The bent portion 424 is a member that rises from within the same plane as that of the second base portion 422 to the height position of the circuit board 6, and connects the second base portion 422 and the connecting portion 425. The connecting portion 425 is connected to the lower surface of the circuit board 6 with a fastener 625 such as a screw. The connecting portion 425 connected to the circuit board 6 and the bent portion 424 are narrower in width in plan view, and have a smaller cross-sectional area than the other portions (portions forming a charge-discharge path (power line)) of the busbar 42. Heat on the circuit board 6 is transferred to the second energy storage device 2B and the first energy storage device 2A through the fastener 625 and the busbar 42. Heat generated in the first energy storage device 2A and the second energy storage device 2B during charge and discharge is transferred to the upper surface of the circuit board 6 through the busbar 42 and the fastener 625.

The busbar 43 electrically connects the positive terminal 22 of the second energy storage device 2B and the negative terminal 23 of the third energy storage device 2C. The busbar 43 includes a first base portion 431, a second base portion 432, a curved portion 433, a bent portion 434, and a connecting portion 435. The first base portion 431 is joined to the positive terminal 22 of the second energy storage device 2B. The second base portion 432 is joined to the negative terminal 23 of the third energy storage device 2C. For joining, an existing technique such as welding is used. The curved portion 433 is a semi-annular member curved upward. The curved portion 433 is provided to accommodate a difference in height between the energy storage devices 2 due to manufacturing variation, to maintain electrical connection between the terminals. The bent portion 434 is a member that includes a portion rising from within the same plane as that of the second base portion 432 to the height position of the circuit board 6 and connects the second base portion 432 and the connecting portion 435. The connecting portion 435 is connected to the lower surface of the circuit board 6 with a fastener 635 such as a screw. The connecting portion 435 connected to the circuit board 6 and the bent portion 434 are narrower in width in plan view, and have a smaller cross-sectional area than the other portions (portions forming a charge-discharge path (power line)) of the busbar 43. Heat on the circuit board 6 is transferred to the third energy storage device 2C and the second energy storage device 2B through the fastener 635 and the busbar 43. Heat generated in the second energy storage device 2B and the third energy storage device 2C during charge and discharge is transferred to the upper surface of the circuit board 6 through the busbar 43 and the fastener 635.

The busbar 44 electrically connects the positive terminal 22 of the third energy storage device 2C and the negative terminal 23 of the fourth energy storage device 2D. The busbar 44 includes a first base portion 441, a second base portion 442, a curved portion 443, a bent portion 444, and a connecting portion 445. The first base portion 441 is joined to the positive terminal 22 of the third energy storage device 2C. The second base portion 442 is joined to the negative terminal 23 of the fourth energy storage device 2D. For joining, an existing technique such as welding is used. The curved portion 443 is a semi-annular member curved upward. The curved portion 443 is provided to accommodate a difference in height between the energy storage devices 2 due to manufacturing variation, to maintain electrical connection between the terminals. The bent portion 444 is a member that rises from within the same plane as that of the second base portion 442 to the height position of the circuit board 6, and connects the second base portion 442 and the connecting portion 445. The connecting portion 445 is connected to the lower surface of the circuit board 6 with a fastener 645 such as a screw. The connecting portion 445 connected to the circuit board 6 and the bent portion 444 are narrower in width in plan view, and have a smaller cross-sectional area than the other portions (portions forming a charge-discharge path (power line)) of the busbar 44. Heat on the circuit board 6 is transferred to the fourth energy storage device 2D and the third energy storage device 2C through the fastener 645 and the busbar 44. Heat generated in the third energy storage device 2C and the fourth energy storage device 2D during charge and discharge is transferred to the upper surface of the circuit board 6 through the busbar 44 and the fastener 645.

The busbar 45 is a member for connecting the positive terminal 22 of the fourth energy storage device 2D to the other external terminal 13B. The busbar 45 includes a base portion 451, a bent portion 452, and a connecting portion 453. The base portion 451 is joined to the positive terminal 22 of the fourth energy storage device 2D. For joining, an existing technique such as welding is used. The bent portion 452 is a member that rises from within the same plane as that of the base portion 451 to the height position of the circuit board 6, and connects the base portion 451 and the connecting portion 453. The connecting portion 453 is connected to the lower surface of the circuit board 6 with a fastener 653 such as a screw.

In FIGS. 3 and 4, the four energy storage devices 2 are connected in series by the busbars 41 to 45. Alternatively, some or all of the energy storage devices 2 may be connected in parallel.

The following describes the configuration of the circuit board 6.

FIG. 5 is a plan view for explaining the configuration of the circuit board 6. The circuit board 6 includes a substrate 60 made of resin and a cutoff circuit 61 disposed on the upper surface of the substrate 60.

The cutoff circuit 61 is a circuit for connecting or disconnecting conduction paths between the busbar 45 connected to the positive terminal 22 of the fourth energy storage device 2D and a busbar 62 connected to the external terminal 13B. The busbar 62 is a plate-shaped conductive member extending in the front-back direction. The rear end of the busbar 62 is fixed to the upper surface of the substrate 60 with a fastener 654 such as a screw. The external terminal 13B is connected to the front end of the busbar 62. The conduction paths between the busbars 45 and 62 are wiring that is formed on the upper surface of the substrate 60 or inside the substrate 60 with a conductive material such as copper or a copper alloy, and have one end electrically connected to the busbar 45 and the other end to the busbar 62.

The cutoff circuit 61 includes, for example, semiconductor switches such as metal oxide semiconductor field effect transistors (MOSFETS). In the example of FIG. 5, six conduction paths extending in the front-back direction are formed as the conduction paths between the busbars 45 and 62. In each of the six conduction paths, two MOSFETs are connected in series (with internal body diodes oriented in opposite directions). The two MOSFETs disposed in each conduction path have a function as a switch to connect or disconnect the conduction path, and also have a function to prevent current outflow from the energy storage devices 2 to the outside and current inflow from the outside to the energy storage devices 2 when the conduction path is disconnected. Alternatively, the cutoff circuit 61 may include relays or on-board switches.

The circuit board 6 further includes first temperature sensors TS11 to TS13, a second temperature sensor TS20, and a third temperature sensor TS30. In the present example embodiment, the first temperature sensors TS11 to TS13 are an example of a temperature sensor (first temperature sensor) that measures the temperature of an area on the circuit board 6. The second temperature sensor TS20 is an example of a temperature sensor (second temperature sensor) that measures the ambient temperature of the circuit board 6. The third temperature sensor TS30 is an example of a sensor (third sensor) that measures the state of a heat-generating component provided on the circuit board 6.

The first temperature sensor TS11 is disposed, for example, in the vicinity of the fastener 625 to measure the temperature of a connection area on the circuit board 6 to which the busbar 42 is connected. The vicinity of the fastener 625 refers to a position where heat of the first energy storage device 2A and the second energy storage device 2B is transferred through the busbar 42 and detected as temperature changes on the upper surface of the circuit board 6. The first temperature sensor TS11 is disposed at a position on the circuit board 6 at which the temperature difference from the temperature of the first energy storage device 2A and the second energy storage device 2B is within an allowable range, as the position in the vicinity of the fastener 625. The first temperature sensor TS11 is a temperature sensor such as a thermistor or a thermocouple with the periphery of a sensor portion insulated by a synthetic resin material or the like.

The first temperature sensor TS12 is disposed, for example, in the vicinity of the fastener 635 to measure the temperature of a connection area on the circuit board 6 to which the busbar 43 is connected. The vicinity of the fastener 635 refers to a position where heat of the second energy storage device 2B and the third energy storage device 2C is transferred through the busbar 43 and detected as temperature changes on the upper surface of the circuit board 6. The first temperature sensor TS12 is disposed at a position on the circuit board 6 at which the temperature difference from the temperature of the first energy storage device 2A and the second energy storage device 2B is within an allowable range, as the position in the vicinity of the fastener 635. The first temperature sensor TS12 is a temperature sensor such as a thermistor or a thermocouple with the periphery of a sensor portion insulated by a synthetic resin material or the like.

The first temperature sensor TS13 is disposed, for example, in the vicinity of the fastener 645 to measure the temperature of a connection area on the circuit board 6 to which the busbar 44 is connected. The vicinity of the fastener 645 refers to a position where heat of the third energy storage device 2C and the fourth energy storage device 2D is transferred through the busbar 44 and detected as temperature changes on the upper surface of the circuit board 6. The first temperature sensor TS13 is disposed at a position on the circuit board 6 at which the temperature difference from the temperature of the third energy storage device 2C and the fourth energy storage device 2D is within an allowable range, as the position in the vicinity of the fastener 645. The first temperature sensor TS13 is a temperature sensor such as a thermistor or a thermocouple with the periphery of a sensor portion insulated by a synthetic resin material or the like.

The second temperature sensor TS20 measures the ambient temperature of the circuit board 6. The ambient temperature of the circuit board 6 refers to the temperature of the space (air) in which the circuit board 6 is installed. The second temperature sensor TS20 is disposed at a position sufficiently separated from the energy storage devices 2, the cutoff circuit 61, and the like so as not to be affected by heat from heat-generating components including the energy storage devices 2. For example, the second temperature sensor TS20 is disposed at a position separated from the fasteners 614, 625, and 645 on the upper surface of the circuit board 6. Alternatively, the second temperature sensor TS20 may be disposed on the cover 12 of the housing case 10, or may be disposed on the busbar frame 46. The second temperature sensor TS20 is a temperature sensor such as a thermistor or a thermocouple with the periphery of a sensor portion insulated by a synthetic resin material or the like.

The third temperature sensor TS30 measures, for example, the temperature of heat-generating components on the circuit board 6. In the example of FIG. 5, the heat-generating components are the semiconductor switches included in the cutoff circuit 61. For example, when the energy storage devices 2 are charged or discharged at high rates, heat generation of the semiconductor switches increases. The third temperature sensor TS30 is disposed in the vicinity of the heat-generating components. The vicinity of the heat-generating components refers to a position where heat of the heat-generating components is transferred and detected as temperature changes on the upper surface of the substrate of the circuit board 6. The third temperature sensor TS30 is a temperature sensor such as a thermistor or a thermocouple with the periphery of a sensor portion insulated by a synthetic resin material or the like.

In the case where a balancer for balancing the charge states (voltages) of the plurality of energy storage devices 2 is mounted on the circuit board 6, the third temperature sensor TS30 may be disposed in the vicinity of the balancer (another example of the heat-generating component).

The circuit board 6 may further include a connector for communication. A communication cable conforming to a communication standard such as the controller area network (CAN) or the local interconnect network (LIN) is connected to the connector. The circuit board 6 communicates with an external device such as a vehicle electronic control unit (ECU) via the communication cable connected to the connector, to receive commands from the external device and transmit necessary data to the external device.

The following describes a management apparatus 100 of the energy storage apparatus 1.

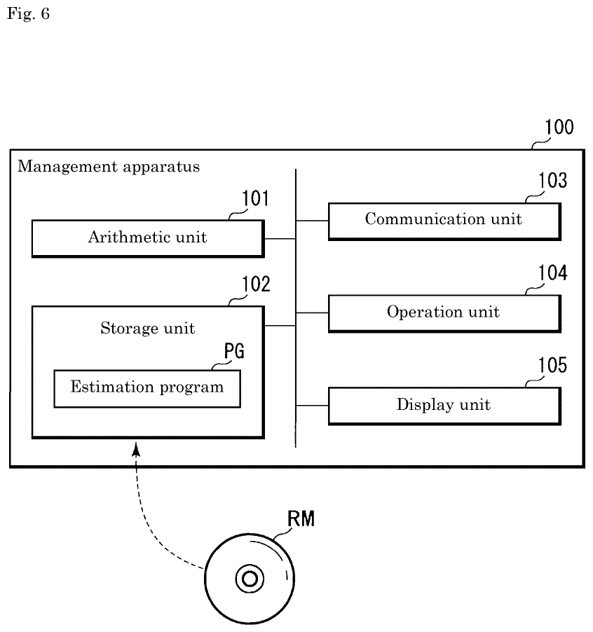

FIG. 6 is a block diagram illustrating the internal configuration of the management apparatus 100. The management apparatus 100 is, for example, a battery management unit (BMU) mounted inside the energy storage apparatus 1. Alternatively, the management apparatus 100 may be a computer such as a terminal device or a server device connected to the outside of the energy storage apparatus 1. The management apparatus 100 includes an arithmetic unit 101, a storage unit 102, a communication unit 103, an operation unit 104, a display unit 105, and the like.

The arithmetic unit 101 is, for example, an arithmetic circuit including a central processing unit (CPU), read only memory (ROM), random access memory (RAM), and the like. The CPU included in the arithmetic unit 101 reads and executes various computer programs stored in the ROM and the storage unit 102, to cause the entire apparatus to function as an arithmetic device that estimates the temperatures of the energy storage devices 2. In the present example embodiment, the arithmetic unit 101 estimates the temperatures of the energy storage devices 2, based on the temperature gradients between the temperatures measured by the first temperature sensors TS11 to TS13 and the temperature measured by the second temperature sensor TS20.

Alternatively, the arithmetic unit 101 may be any arithmetic circuit including a plurality of CPUs, a multi-core CPU, a graphics processing unit (GPU), or a microcomputer, and volatile or nonvolatile memory, and the like. The arithmetic unit 101 may have functions such as a timer to measure the elapsed time from when a measurement start instruction is given to when a measurement end instruction is given, a counter to count numbers, and a clock to output date and time information.

The storage unit 102 includes storage devices such as a flash memory and a hard disk. The storage unit 102 stores various computer programs and data. The computer programs stored in the storage unit 102 include an estimation program PG for causing a computer to perform processing to estimate the temperatures of the energy storage devices 2, based on the temperature gradients between the temperatures measured by the first temperature sensors TS11 to TS13 and the temperature measured by the second temperature sensor TS20. The data stored in the storage unit 102 includes parameters used in the estimation program PG, data generated by the arithmetic unit 101, and the like.

The computer programs including the estimation program PG are provided via a non-transitory recording medium RM on which the computer programs are readably recorded. The recording medium RM is a portable memory such as a CD-ROM, a USB memory, or a Secure Digital (SD) card. The arithmetic unit 101 reads a desired computer program from the recording medium RM using a reader (not illustrated), and stores the read computer program in the storage unit 102. Alternatively, the computer programs may be provided via communication.

The communication unit 103 includes a communication interface for communicating with the circuit board 6. The communication unit 103 receives, from the circuit board 6, temperature data measured by the first temperature sensors TS11 to TS13, temperature data measured by the second temperature sensor TS20, temperature data measured by the third temperature sensor TS30, and the like. The communication unit 103 outputs the temperature data received from the circuit board 6 to the arithmetic unit 101. The arithmetic unit 101 stores the temperature data acquired through the communication unit 103 in, for example, the storage unit 102.

The operation unit 104 includes input devices such as various switches and buttons, and receives a user's operation. The display unit 105 includes a display device such as a liquid crystal display device, and displays information to be notified to the user. Alternatively, the management apparatus 100 may be configured to receive necessary operations through an external computer and transmit information to be notified to the user to the external computer. In this case, the operation unit 104 and the display unit 105 may not be included in the management apparatus 100.

The following describes a temperature estimation method using the management apparatus 100.

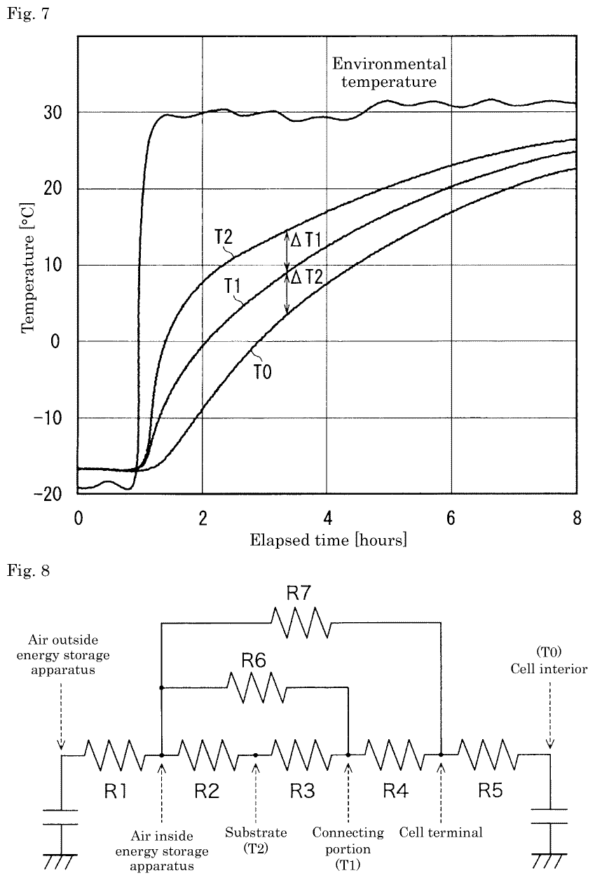

FIG. 7 is a graph showing temporal changes in substrate temperature and cell internal temperature when environmental temperature is abruptly changed. The horizontal axis of the graph represents elapsed time (hours), and the vertical axis represents temperature (° C.). The graph of FIG. 7 shows temporal changes in cell internal temperature T0, connecting portion temperature T1, and substrate temperature T2 when the temperature of the environment in which the energy storage apparatus 1 is installed (environmental temperature) is abruptly changed from −17° C. to 30° C. The environment is an environment assuming that the energy storage apparatus 1 is mounted in the interior of the vehicle, and the energy storage apparatus 1 is heated as the temperature of the vehicle interior rises when the vehicle interior is heated by a heater in the wintertime.

The cell internal temperature T0 represents the internal temperature of each energy storage device 2. In the present example embodiment, the cell internal temperature T0 is a temperature to be estimated by the management apparatus 100. FIG. 7 shows the results of experimentally measuring the internal temperature of the first energy storage device 2A using a temperature sensor (not illustrated).

The connecting portion temperature T1 represents the temperature measured by the first temperature sensor TS11. That is, the connecting portion temperature T1 represents the temperature of the connection area on the circuit board 6 to which the busbar 42 is connected. Since the busbar 42 is connected to the first energy storage device 2A and the second energy storage device 2B, the connecting portion temperature T1 is a temperature reflecting the internal temperatures of the first energy storage device 2A and the second energy storage device 2B.

The substrate temperature T2 represents the temperature measured by the second temperature sensor TS20. That is, the substrate temperature T2 represents the ambient temperature of the circuit board 6.

The graph of FIG. 7 shows how the cell internal temperature T0, the connecting portion temperature T1, and the substrate temperature T2 change with time, following the abrupt change in environmental temperature. That is, the substrate temperature T2 rises as heat outside the energy storage apparatus 1 is transferred to the circuit board 6 through the surrounding air. The connecting portion temperature T1 rises as the heat transferred to the circuit board 6 is transferred to the connection area through the interior of the substrate or the surface of the substrate. The cell internal temperature T0 rises as the heat transferred to the connection area is transferred to the interior of the first energy storage device 2A through the busbar 42 (heat transfer structure).

A transfer path through which heat outside the energy storage apparatus 1 is transferred to the first energy storage device 2A is described by a thermal circuit model. FIG. 8 is a circuit diagram representing a thermal circuit model of the energy storage apparatus 1. The thermal circuit model illustrated in FIG. 8 shows a heat transfer path from the outside of the energy storage apparatus 1 to the interior of the first energy storage device 2A. In the example of FIG. 8, a thermal resistance R1 represents the thermal resistance of a member (housing case 10) that separates air outside the energy storage apparatus 1 from air inside the energy storage apparatus 1. A thermal resistance R2 represents the thermal resistance of a transfer path through which heat transferred to the air inside the energy storage apparatus 1 is transferred to the circuit board 6. A thermal resistance R3 represents the thermal resistance of a transfer path through which the heat transferred to the circuit board 6 is transferred to the connection areas of the busbars 41 and 42. A thermal resistance R4 represents the thermal resistance of a transfer path through which the heat transferred to the connection areas is transferred to the cell terminals through the busbars 41 and 42. A thermal resistance R5 represents the thermal resistance of a transfer path through which the heat transferred to the cell terminals is transferred to the interior of the cell. A thermal resistance R6 represents the thermal resistance of a transfer path through which the heat transferred to the air inside the energy storage apparatus 1 is transferred to the connection areas of the busbars 41 and 42. A thermal resistance R7 represents the thermal resistance of a transfer path through which the heat transferred to the air inside the energy storage apparatus 1 is transferred to the cell terminals. In the case where the heat-generating components (semiconductor switches) provided on the circuit board 6 are taken into account, a thermal resistance connected in parallel to the thermal resistance R3 is added.

In general, heat is transferred by thermal conduction, convection, and thermal radiation, and a thermal resistance (resistance to heat transfer) causes a temperature difference. In situations where the environmental temperature rises, heat outside the energy storage apparatus 1 is transferred to the circuit board 6 through the housing case 10 and the air inside the housing case 10. Since the thermal resistances R1 and R2 are present therebetween, the temperature of the circuit board 6 (substrate temperature T2) is lower than the environmental temperature. The heat transferred to the circuit board 6 is transferred to the connection area through the interior of the substrate ort surface of the substrate. Since the thermal resistance R3 is present therebetween, the temperature of the connection area (connecting portion temperature T1) is lower than the substrate temperature T2. The heat transferred to the connection area is transferred to the interior of the first energy storage device 2A through the busbar 42 (heat transfer structure), the case 21 of the first energy storage device 2A, and the like. Since the thermal resistances R4 and R5 are present therebetween, the internal temperature of the first energy storage device 2A (cell internal temperature T0) is lower than the connecting portion temperature T1.

The inventors of the present application have found that the ratio of the difference ΔT1 between the substrate temperature T2 and the connecting portion temperature T1 to the difference ΔT2 between the connecting portion temperature T1 and the cell internal temperature T0 is nearly constant regardless of the lapse of time. FIG. 9 is a graph showing temporal changes in ratio. The horizontal axis of the graph represents elapsed time (hours), and the vertical axis represents a ratio. A ratio k1 is calculated by ΔT1/ΔT2=(T2−T1)/(T1−T0), using the cell internal temperature T0, the connecting portion temperature T1, and the substrate temperature T2 at each time. As a result of calculating the ratio k1 for the first energy storage device 2A, the ratio k1 remained at a nearly constant value (=0.54) except in a time range in which the environmental temperature abruptly changed (a time range until the elapsed time exceeded approximately 1.2 hours).

FIGS. 7 to 9 illustrate the relationships between the internal temperature of the first energy storage device 2A (cell internal temperature T0) and the connecting portion temperature T1 and the substrate temperature T2. Similar results were obtained for the relationships between the internal temperatures of the second energy storage device 2B through the fourth energy storage device 2D (cell internal temperatures T0) and the connecting portion temperatures T1 and the substrate temperature T2.

For the second energy storage device 2B, a ratio k2 is calculated by ΔT1/ΔT2=(T2−T1)/(T1−T0). A transfer path through which heat outside the energy storage apparatus 1 is transferred to the second energy storage device 2B is different from the transfer path through which heat outside the energy storage apparatus 1 is transferred to the first energy storage device 2A. The thermal resistances R3 to R5 are mainly different between them. Therefore, even if the environmental temperature is uniform, the internal temperature of the second energy storage device 2B is different from the internal temperature of the first energy storage device 2A. As the cell internal temperature T0 at the time of calculating the ratio k2, the internal temperature (actual measured value) of the second energy storage device 2B at each time is used. The internal temperature of the second energy storage device 2B is measured by a temperature sensor (not illustrated). As the connecting portion temperature T1, the temperature at each time of the connection area on the circuit board 6 to which the busbar 42 is connected is used. Alternatively, as the connecting portion temperature T1, the temperature at each time of the connection area on the circuit board 6 to which the busbar 43 is connected may be used. As the substrate temperature T2, the ambient temperature of the circuit board 6 at each time is used.

For the third energy storage device 2C, a ratio k3 is calculated by ΔT1/ΔT2=(T2−T1)/(T1−T0). A transfer path through which heat outside the energy storage apparatus 1 is transferred to the third energy storage device 2C is different from the transfer paths through which heat outside the energy storage apparatus 1 is transferred to the first energy storage device 2A and the second energy storage device 2B. The thermal resistances R3 to R5 are mainly different between them. Therefore, even if the environmental temperature is uniform, the internal temperature of the third energy storage device 2C is different from the internal temperatures of the first energy storage device 2A and the second energy storage device 2B. As the cell internal temperature T0 when the ratio k3 is calculated, the internal temperature (actual measured value) of the third energy storage device 2C at each time is used. The internal temperature of the third energy storage device 2C is measured by a temperature sensor (not illustrated). As the connecting portion temperature T1, the temperature at each time of the connection area on the circuit board 6 to which the busbar 43 is connected is used. Alternatively, as the connecting portion temperature T1, the temperature at each time of the connection area on the circuit board 6 to which the busbar 44 is connected may be used. As the substrate temperature T2, the ambient temperature of the circuit board 6 at each time is used.

For the fourth energy storage device 2D, a ratio k4 is calculated by ΔT1/ΔT2=(T2−T1)/(T1−T0). A transfer path through which heat outside the energy storage apparatus 1 is transferred to the fourth energy storage device 2D is different from the transfer paths through which heat outside the energy storage apparatus 1 is transferred to the first energy storage device 2A through the third energy storage device 2C. The thermal resistances R3 to R5 are mainly different between them. Therefore, even if the environmental temperature is uniform, the internal temperature of the fourth energy storage device 2D is different from the internal temperatures of the first energy storage device 2A through the third energy storage device 2C. As the cell internal temperature T0 at the time of calculating the ratio k4, the internal temperature (actual measured value) of the fourth energy storage device 2D at each time is used. The internal temperature of the fourth energy storage device 2D is measured by a temperature sensor (not illustrated). As the connecting portion temperature T1, the temperature at each time of the connection area on the circuit board 6 to which the busbar 44 is connected is used. As the substrate temperature T2, the ambient temperature of the circuit board 6 at each time is used.

In the present example embodiment, in a learning phase before the actual operation of the energy storage apparatus 1 is started, the internal temperatures T0 of the first energy storage device 2A through the fourth energy storage device 2D, the connecting portion temperatures T1, and the substrate temperature T2 are individually measured, and the ratios k1 to k4 are calculated in advance. The calculated ratios k1 to k4 are stored in the storage unit 102 of the management apparatus 100. In an operation phase after the actual operation of the energy storage apparatus 1 is started, the arithmetic unit 101 of the management apparatus 100 reads the ratios k1 to k4 from the storage unit 102 and measures the connecting portion temperatures T1 and the substrate temperature T2 to estimate the respective internal temperatures T0 of the first energy storage device 2A through the fourth energy storage device 2D. That is, the arithmetic unit 101 estimates the respective internal temperatures T0 of the first energy storage device 2A through the fourth energy storage device 2D, based on the temperature gradients between the temperatures measured by the first temperature sensors TS11 to TS13 and the temperature measured by the second temperature sensor TS20.

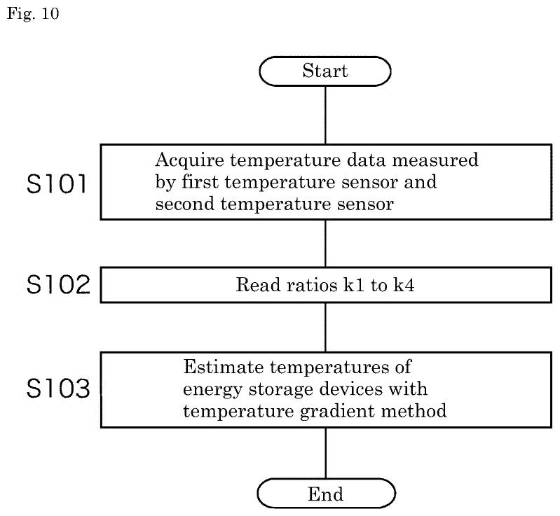

FIG. 10 is a flowchart illustrating a processing procedure performed by the management apparatus 100 according to the first example embodiment. It is assumed that the ratios k1 to k4 for the first energy storage device 2A through the fourth energy storage device 2D have been calculated in advance and stored in the storage unit 102.

The arithmetic unit 101 of the management apparatus 100 acquires temperature data measured by the first temperature sensors TS11 to TS13 and temperature data measured by the second temperature sensor TS20 through the communication unit 103 (step S101).

The arithmetic unit 101 reads the ratios k1 to k4 from the storage unit 102 (step S102). The processing in steps S101 and S102 may be reversed in execution order or performed concurrently.

The arithmetic unit 101 estimates the internal temperatures of the first energy storage device 2A through the fourth energy storage device 2D using a temperature gradient method (step S103). Specifically, the arithmetic unit 101 estimates the internal temperatures (=T0) of the first energy storage device 2A through the fourth energy storage device 2D using the relational expression (T2−T1)/(T1−T0)=k1 (or k2 to k4).

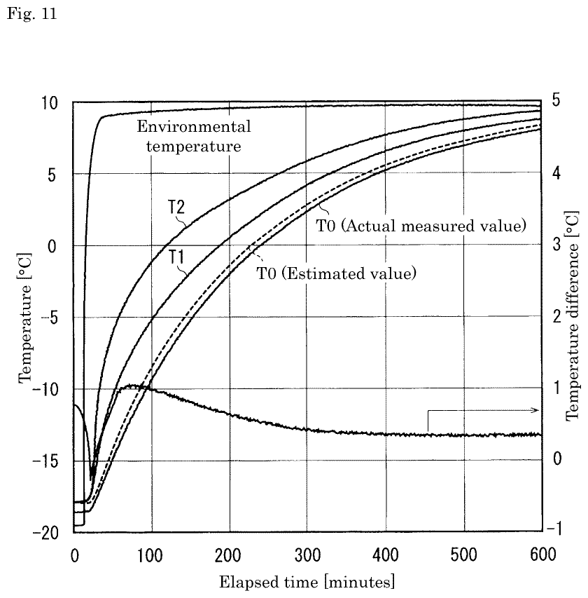

FIG. 11 is a graph showing estimation results in the first example embodiment. The horizontal axis of the graph represents elapsed time (minutes), the left scale of the vertical axis represents temperature (° C.), and the right scale represents temperature difference (° C.). T1 is, for example, the connecting portion temperature measured by the temperature sensor TS11, and represents temperature changes when the environmental temperature is abruptly changed. T2 is the substrate temperature measured by the temperature sensor TS20, and represents temperature changes when the environmental temperature is abruptly changed.

T0 (estimated value) represents the value of the internal temperature of the first energy storage device 2A estimated using the temperature gradient method, based on the connecting portion temperature T1, the substrate temperature T2, and the ratio k1. T0 (actual measured value) shown as a reference represents the actual measured value of the internal temperature of the first energy storage device 2A measured by the sensor (not illustrated).

As a result of the estimation, the temperature difference between T0 (estimated value) and T0 (actual measured value) was about 1.2° C. at the maximum and about 0.5° C. on average. Although the example of FIG. 11 shows the results of the temperature estimation of the first energy storage device 2A, similar temperature estimation results were obtained for the second energy storage device 2B through the fourth energy storage device 2D.

As described above, in the first example embodiment, the internal temperatures of the first energy storage device 2A through the fourth energy storage device 2D can be properly estimated by applying the temperature gradient method.

A second example embodiment describes estimation results in the case where the first temperature sensors TS11 to TS13 are disposed at nearby areas on heat transfer structures close to the energy storage devices 2.

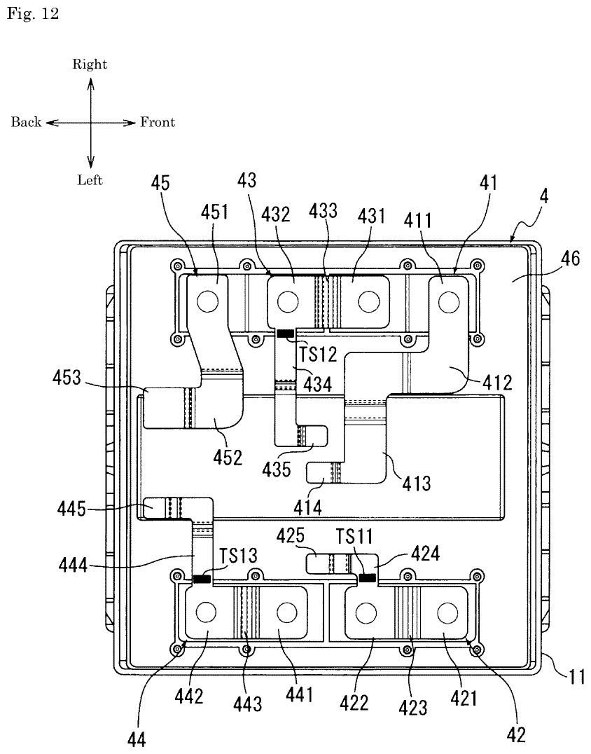

FIG. 12 is an explanatory diagram for explaining the arrangement of the first temperature sensors TS11 to TS13 in the second example embodiment. For the sake of explanation, FIG. 12 illustrates the upper surface of the busbar unit 4 with the circuit board 6 removed.

The first temperature sensor TS11 measures the temperature of a nearby area on the busbar 42 close to the first energy storage device 2A and the second energy storage device 2B. The nearby area refers to a position where heat of the first energy storage device 2A and the second energy storage device 2B is transferred and detected as temperature changes on the busbar 42. The nearby area refers to a position closer to the first energy storage device 2A and the second energy storage device 2B than an area whose temperature is measured by the second temperature sensor TS20. The first temperature sensor TS11 is disposed, for example, at a position on the bent portion 424 close to the second base portion 422. Alternatively, the first temperature sensor TS11 is disposed on the upper surface of the first base portion 421 or the second base portion 422. In the second example embodiment, the first temperature sensor TS11 is an example of a temperature sensor to measure the temperature of a first area at or adjacent to the interior of the energy storage device 2. The second temperature sensor TS20 is an example of a temperature sensor to measure the temperature of a second area farther from the interior of the energy storage device 2 than the first area.

The first temperature sensor TS12 measures the temperature of a nearby area on the busbar 43 close to the second energy storage device 2B and the third energy storage device 2C. The nearby area refers to a position where heat of the second energy storage device 2B and the third energy storage device 2C is transferred and detected as temperature changes on the busbar 43. The nearby area refers to a position closer to the second energy storage device 2B and the third energy storage device 2C than the area whose temperature is measured by the second temperature sensor TS20. The first temperature sensor TS12 is disposed, for example, at a position on the bent portion 434 close to the second base portion 432. Alternatively, the first temperature sensor TS12 is disposed on the upper surface of the first base portion 431 or the second base portion 432. In the second example embodiment, the first temperature sensor TS12 is another example of the temperature sensor to measure the temperature of the first area at or adjacent to the interior of the energy storage device 2.

The first temperature sensor TS13 measures the temperature of a nearby area on the busbar 44 close to the third energy storage device 2C and the fourth energy storage device 2D. The nearby area refers to a position where heat of the third energy storage device 2C and the fourth energy storage device 2D is transferred and detected as temperature changes on the busbar 44. The nearby area refers to a position closer to the third energy storage device 2C and the fourth energy storage device 2D than the area whose temperature is measured by the second temperature sensor TS20. The first temperature sensor TS13 is disposed, for example, at a position on the bent portion 444 close to the second base portion 442. Alternatively, the first temperature sensor TS13 is disposed on the upper surface of the first base portion 441 or the second base portion 442. In the second example embodiment, the first temperature sensor TS13 is an example of the temperature sensor to measure the temperature of the first area at or adjacent to the interior of the energy storage device 2.

In the second example embodiment, as in the first example embodiment, in a learning phase before the actual operation of the energy storage apparatus 1 is started, the internal temperatures T0 of the first energy storage device 2A through the fourth energy storage device 2D, the nearby portion temperatures T1, and the substrate temperature T2 are individually measured, and the ratios k1 to k4 are calculated in advance. Here, the nearby portion temperatures T1 are temperatures measured instead of the connecting portion temperatures T1 in the first example embodiment, and are measured by the first temperature sensors TS11 to TS13 disposed at the areas close to the first energy storage device 2A through the fourth energy storage device 2D. The calculated ratios k1 to k4 are stored in the storage unit 102 of the management apparatus 100. In an operation phase after the actual operation of the energy storage apparatus 1 is started, the arithmetic unit 101 of the management apparatus 100 reads the ratios k1 to k4 from the storage unit 102 and measures the nearby portion temperatures T1 and the substrate temperature T2 to estimate the respective internal temperatures T0 of the first energy storage device 2A through the fourth energy storage device 2D.

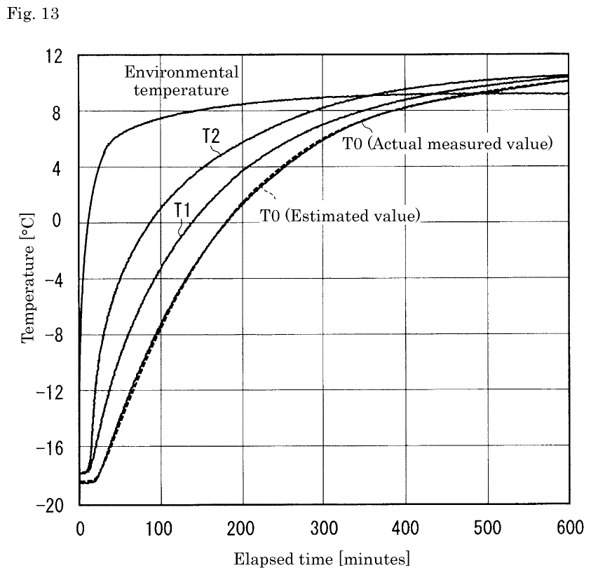

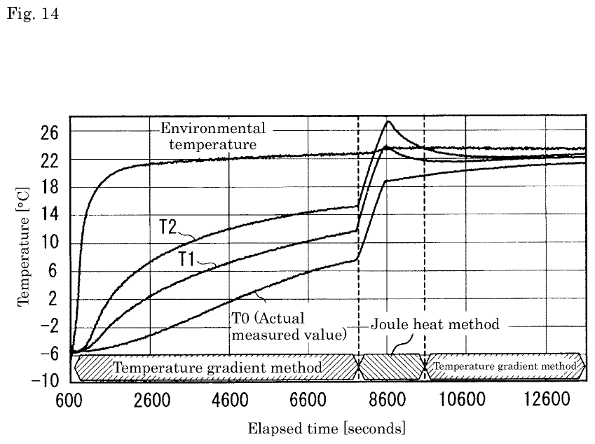

FIG. 13 is a graph showing estimation results in the second example embodiment. The horizontal axis of the graph represents elapsed time (minutes), and the vertical axis represents temperature (° C.). T1 is, for example, the nearby portion temperature measured by the temperature sensor TS11, and represents temperature changes when the environmental temperature is abruptly changed. T2 is the substrate temperature measured by the temperature sensor TS20, and represents temperature changes when the environmental temperature is abruptly changed.

T0 (estimated value) represents the value of the internal temperature of the first energy storage device 2A estimated using the temperature gradient method, based on the nearby portion temperature T1, the substrate temperature T2, and the ratio k1. T0 (actual measured value) shown as a reference represents the actual measured value of the internal temperature of the first energy storage device 2A measured by the sensor (not illustrated).

As a result of the estimation, it has been found that T0 (estimated value) reproduces T0 (actual measured value) very well. Although the example of FIG. 11 shows the results of the temperature estimation of the first energy storage device 2A, similar estimation results were obtained for the second energy storage device 2B through the fourth energy storage device 2D.

As described above, in the second example embodiment, the internal temperatures of the first energy storage device 2A through the fourth energy storage device 2D can be accurately estimated by applying the temperature gradient method using the nearby portion temperatures.

In the second example embodiment, the internal temperature of each energy storage device 2 is estimated by the temperature gradient method using the nearby portion temperature T1 and the substrate temperature T2. Alternatively, the internal temperature of each energy storage device 2 may be estimated by the temperature gradient method using the nearby portion temperature T1 and a cell top surface temperature. Here, the cell top surface temperature refers to the temperature of the upper surface (top surface) of the case 21. The value of the cell top surface temperature is close to but does not completely agree with the internal temperature of each energy storage device 2. Therefore, in the case where highly accurate internal temperature estimation is required, an estimation method using the temperature gradient method is effective.

Alternatively, the internal temperature of each energy storage device 2 may be estimated by measuring the temperatures of any two points having temperature gradients from the interior of the energy storage device, and using the temperature gradient method. For large cells, in which temperature gradients tend to occur, the temperature gradient method is effective. For example, for an energy storage apparatus of an electric vehicle with increased capacity, the internal temperature of the energy storage apparatus can be estimated using the temperature gradient method. The estimated internal temperature is used, for example, to predict the range at low temperatures. The temperature gradient method is also effective for cases where the environmental temperature tends to change, such as vehicles and external energy storage systems. The estimated internal temperature is used, for example, to predict the range at low temperatures of a high-rate vehicle such as an HEV or a PHEV.

A third example embodiment describes a configuration for estimating the temperatures of the energy storage devices 2 by a method based on the current flowing through the energy storage devices 2 instead of the temperature gradient method when the heat-generating components disposed on the circuit board 6 generate heat. The method based on the current flowing through the energy storage devices 2 (second method) is also referred to as a Joule heat method below.

The configuration of the energy storage apparatus 1 and the internal configuration of the management apparatus 100 are the same as those of the first example embodiment, and thus the description thereof will be omitted.

FIG. 14 is an explanatory diagram for explaining the timing of switching between the temperature gradient method and the Joule heat method. The horizontal axis of the graph illustrated in FIG. 14 represents elapsed time (seconds), and the vertical axis represents temperature (° C.). The graph of FIG. 14 shows temperature changes in the substrate temperature T2, the connecting portion temperature T1, and the cell internal temperature T0 in the case where the environmental temperature abruptly changes at an elapsed time of about 600 seconds, and the heat-generating components generate heat when the current from the energy storage devices 2 flows therethrough at an elapsed time of about 7900 seconds. The substrate temperature T2 is a temperature measured by the temperature sensor TS20, and the connecting portion temperature T1 is a temperature measured, for example, by the temperature sensor TS11. The cell internal temperature T0 is the internal temperature (actual measured value) of the first energy device 2A measured by the temperature sensor (not storage illustrated).

In time periods unaffected by heat from the heat-generating components, the ratio of the difference between the substrate temperature T2 and the connecting portion temperature T1 to the difference between the connecting portion temperature T1and the cell internal temperature T0 is nearly constant. In these time periods, the management apparatus 100 estimates the internal temperature of each energy storage device 2 by applying the above-described temperature gradient method. In the example of FIG. 14, the temperature gradient method is applied in the time period in which the elapsed time is 600 to 7900 seconds and the time period in which the elapsed time is 9600 seconds or more.

On the other hand, in a time period affected by heat from the heat-generating components, the ratio of the difference between the substrate temperature T2 and the connecting portion temperature T1 to the difference between the connecting portion temperature T1 and the cell internal temperature T0 is not necessarily constant. When the temperature gradient method is applied in this time period, the accuracy of temperature estimation may decrease. Therefore, the management apparatus 100 according to the third example embodiment switches from the temperature gradient method to the method based on the current flowing through the energy storage devices 2 in the time period affected by heat from the heat-generating components, to estimate the internal temperature of each energy storage device 2. The method based on the current flowing through the energy storage devices 2, in which Joule heat is calculated, is also referred to as a Joule heat method below. In the example of FIG. 14, the Joule heat method is applied in the time period in which the elapsed time is 7900 to 9600 seconds.

In the Joule heat method, a temperature change AT is calculated by the following calculation formula.

ΔT=(Qp+Qs+Qb)/C×Δt

Qp represents generated heat caused by a resistive component inside each energy storage device 2 during energization (Joule heat). The arithmetic unit 101 of the management apparatus 100 calculates the Joule heat Qp by (measured cell voltage value (V)−OCV (V))×measured current value (A). The measured cell voltage value and the measured current value are measured by a voltage sensor and a current sensor (not illustrated). The open circuit voltage (OCV) is given as a function of the state of charge (SOC), for example.

Qs represents absorbed and released heat (reaction heat) due to entropy change during charge and discharge. The arithmetic unit 101 calculates the reaction heat Qs by the estimated cell temperature value (K)×ΔS(J/mol K)×the measured current value (A)/Faraday constant (C/mol). AS is given as a function of the SOC, for example.

Qb represents heat dissipated from the heat source to the surroundings. The arithmetic unit 101 calculates the dissipated heat Qb by (estimated environmental temperature value (° C.)−estimated cell temperature value (° C.))/thermal resistance (C/W). The thermal resistance is a constant that does not change depending on the temperature, and is assumed to be measured in advance. C is the heat capacity of the energy storage device 2, and Δt is energization time.

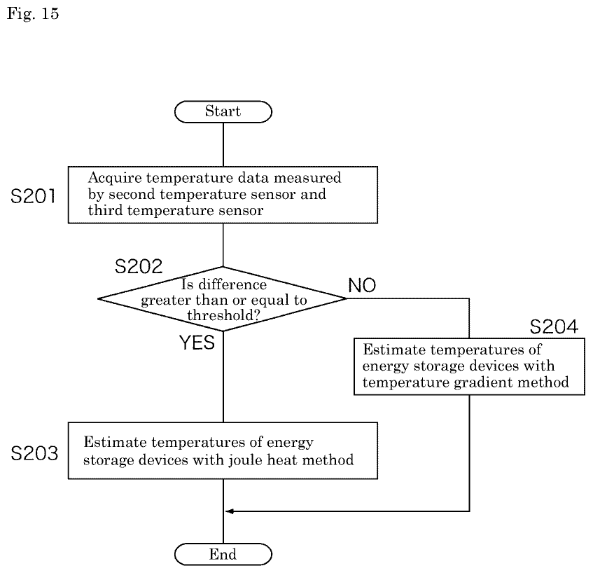

FIG. 15 is a flowchart illustrating a processing procedure performed by the management apparatus 100 according to the third example embodiment. The arithmetic unit 101 of the management apparatus 100 acquires temperature data measured by the second temperature sensor TS20 and temperature data measured by the third temperature sensor TS30 through the communication unit 103 (step S201). The arithmetic unit 101 performs the following processing each time the temperature data measured by the second temperature sensor TS20 and the temperature data measured by the third temperature sensor TS30 are acquired.

The arithmetic unit 101 determines whether or not the difference between the temperature 4 the heat-generating components and the substrate temperature T2 is greater than or equal to a threshold, based on the acquired temperature data (step S202). In the present example embodiment, the heat-generating components are the semiconductor switches included in the cutoff circuit 61. The threshold is, for example, 3° C.

When it is determined that the difference between the temperature of the heat-generating components and the substrate temperature T2 is greater than or equal to the threshold (S202: YES), the arithmetic unit 101 estimates the temperatures of the energy storage devices 2 with the Joule heat method (step S203). The arithmetic unit 101 estimates the temperatures of the energy storage devices 2 by calculating the temperature changes ΔT in the energy storage devices 2 using the calculation formula ΔT=(Qp+Qs+Qb)/C×Δt.

When it is determined that the difference between the temperature of the heat-generating components and the substrate temperature T2 is less than the threshold (S202: NO), the arithmetic unit 101 estimates the temperatures of the energy storage devices 2 with the temperature gradient method (step S204). A method for estimating the temperatures of the energy storage devices 2 using the temperature gradient method is the same as that in the first example embodiment. That is, the arithmetic unit 101 acquires temperature data measured by the first temperature sensors TS11 to TS13 and temperature data measured by the second temperature sensor TS20 through the communication unit 103, and performs calculation using the ratios k1 to k4, thereby estimating the internal temperatures of the first energy storage device 2A through the fourth energy storage device 2D.

As described above, in the third example embodiment, when the temperature of the heat-generating components is greater than or equal to the threshold, switching to the Joule heat method is performed to estimate the temperatures of the energy storage devices 2, so that the temperatures of the energy storage devices 2 can be accurately estimated regardless of the operating status of the energy storage apparatus 1.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device;
a circuit board;
a first temperature sensor to measure a temperature of an area on the circuit board or a first area at or adjacent to an interior of the energy storage device;
a second temperature sensor to measure an ambient temperature of the circuit board or a temperature of a second area that is farther from the interior of the energy storage device than the first area; and
an arithmetic device including a processor and a memory, the memory including a program that is executable by the processor to cause the processor to estimate a temperature of the energy storage device based on a temperature gradient between the temperature measured by the first temperature sensor and the temperature measured by the second temperature sensor.

2. The energy storage apparatus according to claim 1, further comprising a plurality of the energy storage devices adjacent to each other; wherein
the arithmetic device is configured or programmed to estimate a temperature of each of the plurality of energy storage devices based on a difference between the temperature measured by the first temperature sensor and the temperature measured by the second temperature sensor, and a difference between the temperature of the area on the circuit board or the first area and the temperature of the energy storage device acquired in advance.

3. The energy storage apparatus according to claim 1, further comprising:
a heat-generating component provided on the circuit board; and
a third sensor to measure a state of the heat-generating component; wherein
the arithmetic device is configured or programmed to:
estimate the temperature of the energy storage device based on a current flowing through the energy storage device instead of the temperature gradient, according to the state measured by the third sensor.

4. The energy storage apparatus according to claim 3, wherein the heat-generating component is a switch configured to turn on or off energization of the energy storage device.

5. A management apparatus comprising:
a processor;
a memory including a program executable by the processor to function as:
an acquisition unit configured or programmed to acquire temperature data from a first temperature sensor to measure a temperature of an area on a circuit board or a first area at or adjacent to an interior of an energy storage device, and a second temperature sensor to measure an ambient temperature of the circuit board or a temperature of a second area that is farther from the interior of the energy storage device than the first area; and
an estimation unit configured or programmed to estimate a temperature of the energy storage device based on a temperature gradient between the temperature measured by the first temperature sensor and the temperature measured by the second temperature sensor.

6. A method for estimating a temperature of an energy storage device comprising processing performed by a computer including:
acquiring temperature data from a first temperature sensor to measure a temperature of an area on a circuit board or a first area at or adjacent to an interior of the energy storage device;
acquiring temperature data from a second temperature sensor to measure an ambient temperature of the circuit board or a temperature of a second area that is farther from the interior of the energy storage device than the first area; and
estimating a temperature of the energy storage device based on a temperature gradient between the temperature measured by the first temperature sensor and the temperature measured by the second temperature sensor.

7. A non-transitory computer-readable medium including a computer program executable to cause a computer to perform processing including:
acquiring temperature data from a first temperature sensor to measure a temperature of an area on a circuit board or a first area at or adjacent to an interior of an energy storage device;
acquiring temperature data from a second temperature sensor to measure an ambient temperature of the circuit board or a temperature of a second area that is farther from the interior of the energy storage device than the first area; and
estimating a temperature of the energy storage device based on a temperature gradient between the temperature measured by the first temperature sensor and the temperature measured by the second temperature sensor.
